(19) United States
(12) Patent Application Publication
(10) Pub. No.: US 2016/0096612 A1
(43) Pub. Date: Apr. 7, 2016

(54) SUPER-PRESSURE BALLOON

(71) Applicant: Aether Industries, LLC., Pasadena, CA (US)

(72) Inventors: Benjamin Longmier, Pasadena, CA (US); John Mark Guthery, Del Valle, TX (US); John Patrick Sheehan, Ann Arbor, MI (US)

(21) Appl. No.: 14/870,288

(22) Filed: Sep. 30, 2015

Related U.S. Application Data
(60) Provisional application No. 62/059,119, filed on Oct. 2, 2014.

(51) Int. Cl. B64B 1/44; B64B 1/58

(52) U.S. Cl. CPC B64B 1/44; B64B 1/58

(57) ABSTRACT

A payload delivery and recovery system, having a payload including a data collection device arranged to collect data, and a controllable ascent vehicle comprising a controllable lighter than air (LTA) mechanism detachably coupled to the payload and used during an ascent phase to deliver the payload to a pre-determined altitude. The LTA mechanism includes low cost super-pressure balloons.

### CROSS-REFERENCE TO RELATED APPLICATIONS

The present application claims the benefit under 35 U.S.C. 119(e) of U.S. Provisional Application No. 62/059,119 entitled “LOW COST SUPERPRESSURE BALLOONS,” filed Oct. 2, 2014, which is incorporated herein by reference in its entirety.

### FIELD

The described embodiments generally relate to mechanisms for controlling the ascent and descent of a payload in the Earth's atmosphere. More specifically, embodiments relate to a buoyancy system for controlling ascent of a payload and guided descent apparatus including a control system for controlling descent of the payload.

### BACKGROUND

Presently, data collection devices are floated above the Earth's surface to collect specific data. For example, balloons are used to suspend various devices and sensors above the surface of the Earth for collection of data for commercial use as well as for experimental and scientific research. One example is weather data collection where sensors are attached to a weather balloon, which is released into the Earth's atmosphere. The weather balloon rises above the Earth and the sensors record information.

Weather balloons are often made of latex, rise vertically from the Earth's surface into the atmosphere and pop after a period of time as the external air pressure decreases, causing the balloon to expand beyond the elastic limit of the balloon material. Accordingly, the resulting sensor and associated data collection path is generally along a vertical profile that is ultimately controlled by air currents and upper level winds, with respect to the Earth's surface, as the balloon ascends above the Earth.

### SUMMARY

Embodiments described herein relate to a low cost super-pressure balloon.

A high altitude super-pressure balloon system includes a plastic film tube having a film tube length, wherein a super-pressure balloon float altitude is selectable in accordance with the film tube length and a given payload mass. An ability of the super-pressure balloon to drift at a known and fixed altitude to take advantage of known or unknown wind patterns in order to pass over a desired location or plurality of locations on the ground. The system also includes a payload coupled to the tube of plastic film.

A method of manufacturing a super-pressure balloon is carried out by acquiring a tubular material capable of being formed in a collapsed and expanded configuration having a length longer than an intended length of the super-pressure balloon, removing a desired length of tubular material to create the super-pressure balloon, and sealing the terminal ends of the tubular material to form the super-pressure balloon.

### BRIEF DESCRIPTION OF THE DRAWINGS

The invention will be readily understood by the following detailed description in conjunction with the accompanying drawings, wherein like reference numerals designate like structural elements, and in which:

FIG. 1 illustrates a payload delivery and recovery system in various operational phases in accordance with the described embodiments;

FIG. 2 shows a schematic of a payload delivery and recovery system in accordance with the described embodiments;

FIGS. 3A and 3B show an embodiment of a payload system above the Earth's surface in an ascent phase and a deployment phase respectively, in accordance with the described embodiments;

FIG. 4 shows representative super-pressure balloon system 400 in accordance with the described embodiments;

FIG. 5 is flow chart illustrating steps for operating a payload delivery and recovery system in accordance with the described embodiments.

FIG. 6 shows an exemplary flight path of a payload;

FIGS. 7-11 each show calculated float altitude in accordance with super-pressure balloons having varying widths as a function of payload mass; and

FIG. 12 is a block diagram of an electronic device suitable for use with the described embodiments.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments described herein relate to a low cost super-pressure balloon. An exemplary super-pressure balloon according to embodiments described herein may be able to float at a fixed altitude (or variable altitude) in order to navigate over a fixed point or area on the ground (individual building, city, metro area, or desired mapping location), as it blows in the wind. In practice, the super-pressure balloon can achieve an altitude selection in increments as fine as 250 feet between an altitude band from about 10,000 feet to about 100,000 feet.

A super-pressure balloon is a style of lighter than air balloon where the volume of the balloon is kept relatively constant regardless of the varying local air temperature and temperature of the contained lifting gas. The balloon envelop is kept at a constant volume by insuring that the pressure within the balloon is always greater than the air pressure at the float altitude of the balloon. This property of constant volume allows the super-pressure balloon to remain at a relatively fixed and stable altitude, even during diurnal changes in air temperature and as the solar heating of the balloon is present in the day and is not present at night. Stable float is possible for many days, weeks, or months with super-pressure balloons, and for as long as the balloon retains positive buoyancy in the atmosphere. Materials with low helium or hydrogen permeability are used so that helium or hydrogen leak rates out of the balloon are minimize.

The super-pressure balloon can be used with a data acquisition system that uses a payload having a data collection device used to collect, and in some cases process, data. In one embodiment, the data collection device can be lofted above the surface of the Earth using, for example, an ascent vehicle. The ascent vehicle can take many forms. However, in the context of this discussion, the ascent vehicle can take the form of lighter than air (LTA) mechanisms and apparatuses that can be used to control the ascent of a payload in the atmosphere above the Earth's surface. It should be noted that LTA mechanisms and apparatuses can include, for example, balloons, dirigibles, and so forth and an ascent vehicle can be any device that is useful to transport the payload into the Earth's atmosphere. It should be noted that in general a LTA mechanism and apparatus, as a whole, has a density less than the volume of air that it displace and will therefore have a positive buoyancy (even though some individual subcomponents may be lighter or heavier than air). It should also be noted is that the mass of the payload can be kept to less than about 2 kg. In this way, when the LTA mechanism is in the form of a balloon, it can be classified as a “Light” unmanned free balloon per the International Civil Aviation Organization (ICAO) regulations.

In some embodiments, the payload can be a digital sensor or other data collection device. In one embodiment, the payload can be carried aloft by a high altitude balloon system and therefore can be capable of aerial imaging functions, telecommunications relay functions, or other functions normally associated with a satellite in space. Moreover, the payload can be designed for mass production at a low cost. A low cost payload can include for example, a printed circuit board (PCB) requiring only minimal post-production assembly. During an ascent phase, the payload can be carried aloft by a (high altitude) balloon system up to a fixed, or in some cases a variable, altitude so that the payload can carry out the pre-determined functions such as aerial imaging or telecommunication relay. The payload can operate over a period of time above a location on the ground like a city, state, country, or larger geographical area for example, as it is carried by the wind or other air currents (such as the jet stream).

In some embodiments, an ascent vehicle can take the form of a balloon system that includes one or more first balloons that provide positive buoyancy. These balloons can be filled with gases having a density less than air (such as helium) and be formed of a material such as latex. The balloons can also take the form of, zero-pressure balloons, super-pressure balloons or similar balloons. It should be noted that the positive buoyancy system could provide fixed or variable positive buoyancy. In addition the balloon system can include, one or more second balloons (such as the super pressure balloon) filled with one or more gases or liquids with a high vapor pressure that provides negative buoyancy to the balloon system. The negative buoyancy balloons can provide fixed or variable negative buoyancy to the system and can provide negative buoyancy at and above a chosen altitude. The amount of negative buoyancy can be determined by the volume of the negative buoyancy balloons and the initial quantity of gas or liquid within the negative buoyancy balloons. The negative buoyancy balloons can be constructed out of a high strength material and/or a plurality of high strength cords or tendons, which further increase the strength of the balloons and hence increases the working pressure within the balloons.

It should be noted that at the operating altitudes for the described embodiment, a large amount of ground coverage could be achieved for telecommunications and imagery applications. While it is less ground coverage when compared to a satellite, it is more ground coverage than that of a typical manned or unmanned airplane. For example, at 100,000 ft., the described balloon systems and payload can have a ground coverage circle, for imagery applications for example, of about 1000-miles in diameter.

In some embodiments, the ascent vehicle can be configured to ascend to a pre-determined range of altitude by taking advantage of wind patterns to position the payload system relative to corresponding surface location on the ground. In some embodiments, the payload can include a data-acquiring device. In some embodiments, the payload determines a landing location based on conditions detected by the data-acquiring device and/or pre-stored geographic descriptors of locations within range of the payload. In some embodiments, the payload can be a camera arranged to acquire images of pre-selected locations on a surface of the Earth. In some embodiments, the payload can include a wireless transceiver capable of wireless transmission of data and/or wireless reception of commands and/or data.

Conventional super-pressure balloons have been relatively expensive to construct due to the long lengths of seams that must be used to build the balloons into shape that can withstand the pressure difference between the balloon and the low-density atmosphere. Typical sphere or spheroid shapes are used. Polyethaleyene (LDEP, LLDPE, MDPE, or HDPE) or Mylar materials are common due to their low density, relatively high strength against plastic deformation (yielding) and low permeability to helium and hydrogen. Typically, large panels are cut out of flat sheets of these plastic materials, and tens or hundreds of these pieces are seamed together (RF weld, melt weld, etc), requiring many hundreds or thousands of hours to assembly. In contrast, the described embodiments take advantage of a naturally strong cylindrical shape of the tube plastic, which does not require any seams that are always the weakest point in the balloon.

The low cost super-pressure balloon described herein reduces the number of required seams and may remove all seams from the balloon envelope, thereby increasing the strength of the balloon and significantly reducing the cost of the balloon and manufacturing process due to the large number of man-hours needed to seal the super-pressure material together in a way without any flaws. A single flaw in the seams can cause the balloon to have a catastrophic failure. In our design, we use a continuous cylinder (or tube) of plastic film, which can remove all seams, and only leaves the ends of the plastic tube to seal. In our design, we gather the plastic film and tie a knot at the ends of the tube in order to form a gas-tight seal. Alternatively metal or plastic banding can be used to seal the ends.

It should be noted that the tubes can be formed of a single layer or multiple layers, as is commonly produced at the industrial scale for many polymer applications. Up to 7 layers can be easily achieved. With this process, multiple layers can be added for strengthening the balloon tube material, and one layer can serve as a helium barrier while a separate layer serves as a strength element. Reinforced fiberglass material can also be inserted between the layers for added strength, completely removing any post-manufacturing assembly of the balloons.

The altitude at which the super-pressure balloons described herein can float at can be selected based on the length of the tube used to construct the balloon, and this float altitude decision can be made “in the field” and doesn't need to be made days or weeks ahead of the flight as with other super-pressure designs. This makes the balloons quite useful for real-time decision-making in flight logistics. Further, the tubing material is stored on a large roll (1200 foot long rolls are typical), which makes transportation, storing, and handling straightforward and requires little time to assemble in the field. In this way, thousands of balloons can be shipped on a single shipping pallet to a single location.

Some embodiments can include a payload delivery and recovery system, having a payload including a data collection device arranged to collect data and a controllable ascent vehicle including a controllable lighter than air (LTA) mechanism detachably coupled to the payload and used during an ascent phase to deliver the payload to a pre-determined altitude. The payload delivery and recovery system can also have a controllable descent mechanism releasably attached to the controllable ascent vehicle that can be used during a descent phase for reducing a rate of descent of the payload subsequent to release of the payload at the pre-determined altitude and including a control system for navigating the payload to a desired ground location during a recovery phase.

The payload that is carried to an altitude above the ground in order to capture aerial images (infrared, visible, UV, or multispectral), perform telecommunications operations (the functions of a WiFi router or other telecommunications relays, at any RF spectrum or with a free-space optical communications system), perform signal intelligence (detect RF or optical signals from below), or perform other functions normally associated with the functions that an artificial satellite in space.

In practice, the LTA vehicle is made to navigate over a desired location on the ground by choosing an appropriate launch location on the ground, and using knowledge of the atmospheric winds as a function of altitude to choose a fixed altitude of the super-pressure balloon system. The float duration of the balloon may be any time increment from several minutes to several weeks or months. Data from the payload can be recovered by physically returning an onboard data storage device (SD card) to the ground or by transmitting the data back to the ground using an RF transmitter or free-space-optical communications device.

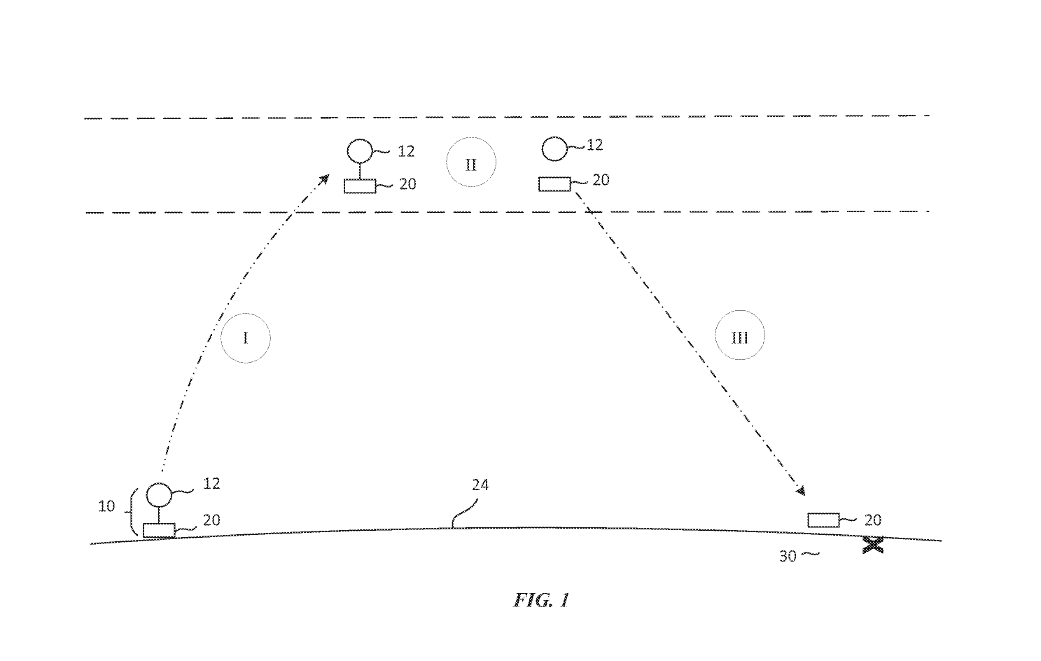

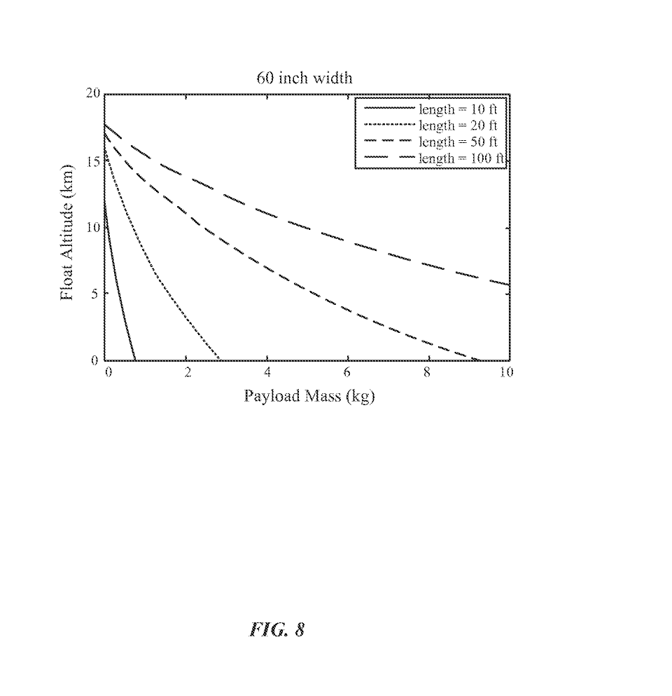

These and other embodiments are discussed below with reference to FIGS. 1-8. However, those skilled in the art will readily appreciate that the detailed description herein with respect to these figures is for explanatory purposes only and should not be construed as limiting.

FIG. 1 illustrates a payload system in various operational phases in accordance with the described embodiments. Payload system 10 can include an ascent vehicle that in this particular embodiment takes the form of LTA mechanism 12 attached to payload 20. LTA mechanism 12 can be a balloon, dirigible, or any other mechanism having a composition of components that combine to have an overall density less than an amount of displaced air and is therefore lighter than the displaced air at a given point in the Earth's atmosphere such that the altitude of LTA mechanism 12 can be controlled by buoyancy of LTA mechanism 12. In ascent phase I, the overall positive buoyancy of LTA mechanism 12 causes payload system 10 to rise off of the Earth's surface 24 and rise into the atmosphere until a desired altitude is reached. Once the desired altitude is reached, in a deployment phase II, payload 20 is deployed from the LTA mechanism 12. Deploying the payload 20 can be done by payload 20 separating from LTA mechanism 12. Separation can be initiated by LTA mechanism 12 or by the payload 20. It is also possible that the LTA mechanism 12 is integrated within the payload 20 and as such does not become separated from the LTA mechanism 12.

After payload 20 has been deployed, the payload 20, by way of a descent mechanism, described further below in various embodiments, can guide the payload down toward a desired landing site 30 in a recovery phase III. Data collection and transmission can occur during any or all of the phases described. Data can be transmitted during any of the operational phases by way of remote transmission or data can be physical collected by recovering the payload 20 from the landing site 30 and downloading the data.

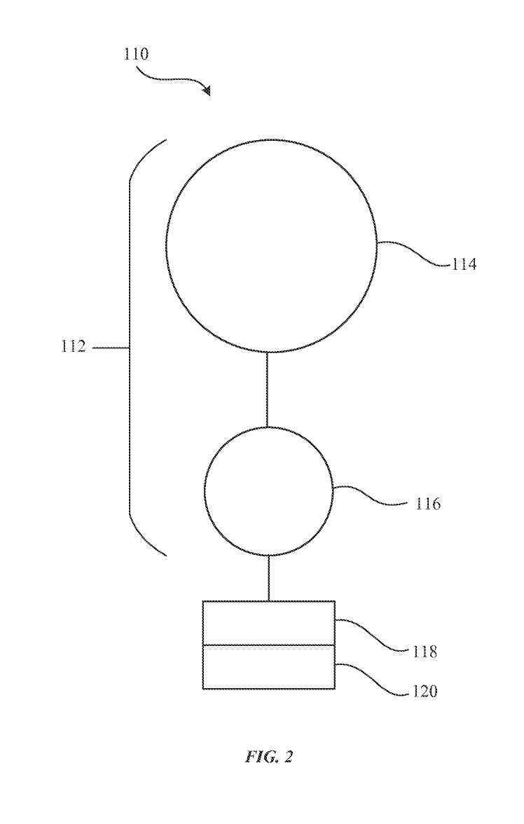

The LTA mechanism, descent mechanism and payload described above can take many forms. FIG. 2 illustrates a schematic of an embodiment of payload system 110 in accordance with the described embodiments. Payload system 110 can be formed of lighter than air (LTA) mechanism 112, which is made up of a positive buoyancy portion 114 and a negative buoyancy portion 116. Payload system 110 also includes a payload 120 that is coupled to the LTA mechanism 112. The payload 120 can be directly coupled with LTA mechanism 112 or by way of a descent mechanism 118, as shown. Since payload 120 is coupled to the LTA mechanism 112, when the payload system 110 is launched, the buoyancy of the LTA mechanism 112 controls the ascent of the payload system 110, during an ascent phase, carrying the payload 120 to a desired altitude. The positive buoyancy portion 114 and negative buoyancy portion 116 of the LTA mechanism 112 can be coupled together in any number of configurations. For instance, a tether such as a string, wire or cord, can connect the portions. The portions can also be conjoined, integrated within one another, such as one balloon being located inside the other, or combined in any number of other ways.

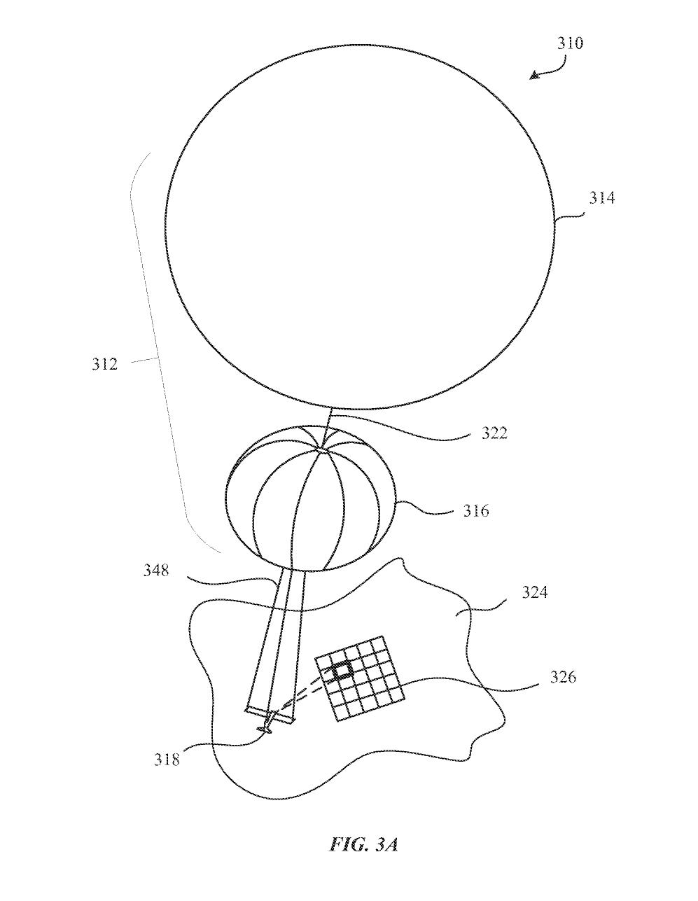

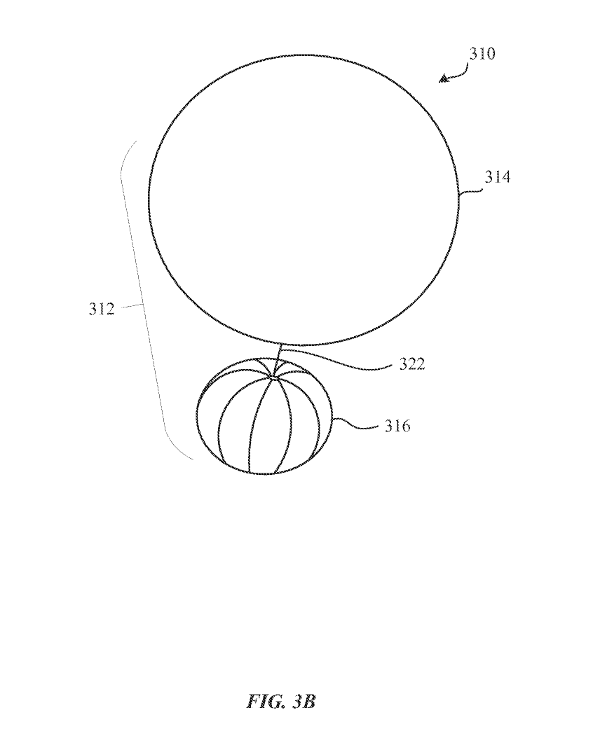

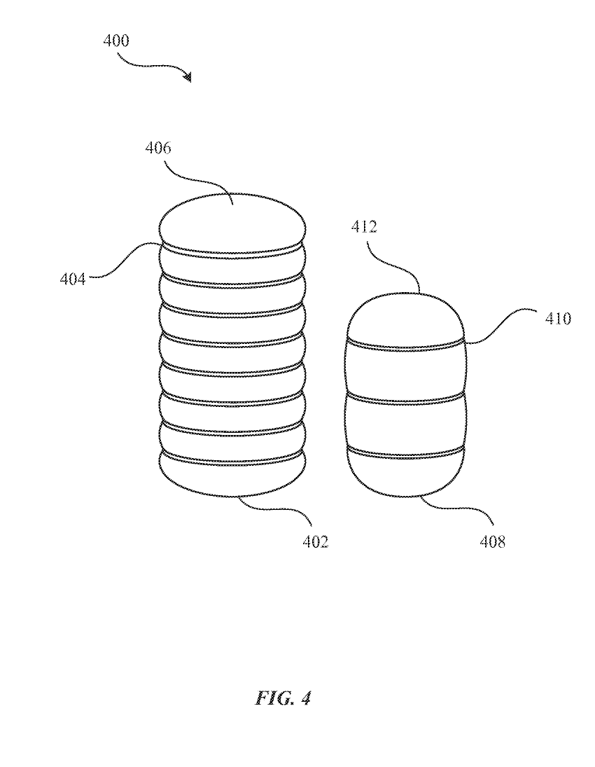

FIGS. 3A and 3B illustrate one embodiment of a payload system 310 shown at altitude over the Earth's surface 324, in accordance with the described embodiments. FIG. 3B shows the payload system 310 in the ascent phase as it rises to a desired altitude in the atmosphere and FIG. 3B shows a descent mechanism 318 (which is coupled to a payload illustrated in FIG. 4 and described further blew) of payload system 310, in a deployed state during the deployment phase.

FIG. 3B shows payload system 310 including a lighter than air (LTA) mechanism 312, that includes (high pressure) positive buoyancy balloon 314 and (super pressure) negative buoyancy balloon 316. It should be noted that although balloons 314 and 316 are shown as having a spherical or spheroidal shape, any shape is suitable. For example, balloons 314 and/or 316 can have a tear drop shape, a cylindrical shape, and so on. Descent mechanism 318 can be tethered to the negative buoyancy balloon 316 of the LTA mechanism 312 by three payload tethers 348. In FIG. 3B descent mechanism 318, is illustrated detached or deployed from LTA mechanism 312. FIG. 3c illustrates representative super-pressure balloon in accordance with the described embodiments.

With regard to the LTA mechanism 312, negative buoyancy balloon 316 is tethered to positive buoyancy balloon 314 by way of a balloon tether 322. Descent mechanism 318 takes the form of a glider, which acts to control the descent of payload 320. As seen in FIG. 4, payload 320 is coupled to descent mechanism 318 and in one embodiment, payload 320 uses a gimbal system to point the data collection device (such as a camera) at multiple locations on the ground 324 using, for example, a grid pattern 326 to take high-resolution images.

It should be noted that positive buoyancy balloon 314 could be formed of many strong and lightweight materials and filled with gases having a density less than a corresponding volume of air. Positive buoyancy balloon 314 can be filled with a liquid or gas composition that can provide positive buoyancy. For example, a lightweight and strong material can be latex and the filler gas can be helium or hydrogen (helium is preferred due to the inert nature of helium as opposed to the flammability of hydrogen). Accordingly, positive buoyancy balloon 314 can take the form of latex helium balloon, zero-pressure helium balloon, super-pressure helium balloon or similar balloon configurations. Negative buoyancy balloon 316 can be a super-pressure balloon filled with one or more of gases, or liquids with a high vapor pressure such as air, nitrogen, SF₆, ammonia, butane, methane, 1,1-difluoroethane, 1,1,1-trifluoroethane, or 1,1,1,2-tetrafluoroethane or other composition that can provide fixed or variable negative buoyancy.

Super-pressure refers to having a pressure greater inside a super-pressure balloon than outside the balloon and zero-pressure refers to the pressure inside of a balloon being the same as the pressure outside of the balloon. Super-pressure balloons can be composed of a low-stretch material, plastic sheeting, polyethylene, Mylar, PVC, rip-stop nylon, or other similar material. The positive buoyancy balloon 314 and negative buoyancy balloon 316 can individually be fixed or variable volume. That is to say, they can be stretchy latex type balloons or fixed volume balloons. The latex balloons can be unmodified or have an interior coating of a liquid polymer to reduce helium diffusion, which increases the aloft lifetime of the balloon. Super-pressure balloons can have strings, cords, or tendons around the circumference in order to increase the total burst strength of the balloon, and hence increase the burst pressure of the balloon. All the balloons are preferably made of biodegradable or environmentally friendly materials.

Prior to launch, the negative buoyancy super-pressure balloon 316 can be filled with a known amount of air, or other gas, or liquid with a high vapor pressure, in order to select the altitude at which the negative buoyancy balloon 316 will go super-pressure, or in other words, when the pressure inside of the balloon exceeds the pressure outside of the balloon. When the negative buoyancy balloon 316 balloon goes super-pressure, it then starts providing negative buoyancy to the overall LTA mechanism 312 where gravity pulls the payload system 310 back down towards the Earth's surface to a lower altitude. Additional control of the altitude position of LTA mechanism 312 can be accomplished by utilizing air pumps and relief valves (not shown), which can be used to add gas or remove gas from the negative buoyancy balloon 316 while at altitude. This increases or decreases the float altitude of the payload system 310 as a whole. By changing altitude, different wind directions can be chosen for navigational purposes.

FIG. 4 shows representative super-pressure balloon system 400 in accordance with the described embodiments. As shown, representative super-pressure balloon 402 can have a length of about 8 feet length balloon with reinforcing fiberglass tape 404 placed at intervals (such as every 6 inches along the polyethylene tube 406. Super-pressure balloon 408, on the other hand, can have a length of about 6 feet with reinforcing fiberglass tape 410 placed a greater distance apart (such as every 12 inches along the polyethylene tube 412). It should be noted that the tube circumference is on the order of about 96 inches, and is formed of Low Density PolyEthylene (LDPE) plastic film having a thickness of 1.5 mil (1.5 thousandths of an inch). It should be noted that additional reinforcing tape creates stronger balloons, but at the expense of making the balloon heavier.

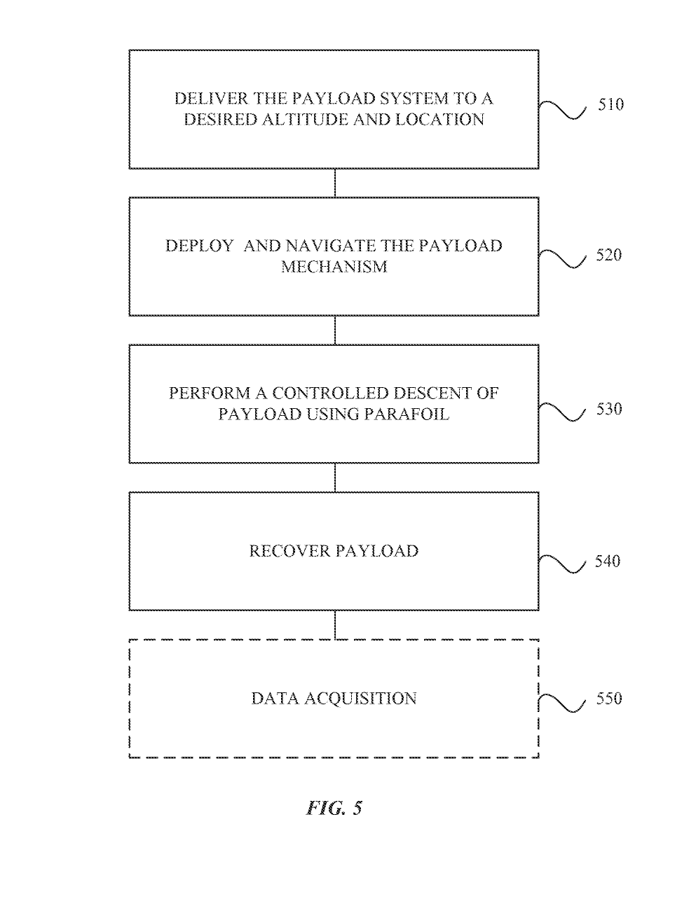

FIG. 5 is flow chart illustrating steps for operating a payload system in accordance with the described embodiments. The steps are described in relation to the embodiment shown in FIGS. 3A, 3B and 4. In operation, descent mechanism 318 is tethered to LTA mechanism 312. A desired altitude is selected given atmospheric wind patterns for locating payload 320 at a particular altitude and location for collecting the particular data desired. The buoyancy of LTA mechanism 312 is calculated for the desired altitude and is used to determine the appropriate buoyancy of each positive buoyancy balloon 314 and negative buoyancy balloon 316. The appropriate gases and/or liquids are filled into each respective balloon. It should be noted that glider 318 and payload 320 could be attached to the LTA mechanism 312 at any point prior to launch of the payload system. The payload system is launched and then delivered in an initial step 510 into the atmosphere, beginning an ascent phase, and where payload system 310 controllably rises up to its desired location carrying the glider 318 and payload. Once payload system 310 is at its desired altitude, changes to the altitude can be made to the payload system 310 by remote control or pre-programmed instructions, by modifying the buoyancy of negative buoyancy balloon 316, for example, using the air pumps and relief valves.

In some embodiments, the descent to the ground can be such that the payload lands back at the launch location if the payload has enough range to do so. If, however, the LTA mechanism and payload system drifts farther downwind from the launch location than glide range of the payload, the payload can make a decision to land instead at one of a number of pre-designated landing locations. These multiple pre-programmed alternate landing locations can be single points on the ground or entire swaths or regions of land, which are defined at the time of programming the payload in the lab. Alternatively, the payload could receive updated landing location sites or zones via communications from the ground or satellite relay. Real time decision making capability may be built into the payload system such that on descent, the payload is continuously calculating the glide range based on its current location, air speed, ground speed, wind direction, etc. A real-time and automated decision can be made onboard the glider for calculating the best-landing zone within glide distance.

A large number of safe landing zones can be defined around the US in order to foster participation on private lands, and a rewards based system can be implemented for setting up the landing zones. In one example, a farmer can be paid a nominal recovery fee for every glider payload that lands on his farm. Additionally, the farmer can agree to package up the glider and ship it back to a lab via a pre-paid mailing container.

In some embodiments the glider and payload are configured to be disassembled with simple tools or hands-only by a single person. A recovered glider that can be disassembled will result in parts that are a convenient size and shape designed to fit directly into pre-existing shipping boxes. One or more gliders can be collected during a given time period by a collector such as a rural farmer. As gliders land and/or accumulate, collectors may collect immediately as they see gliders land and/or are notified via electronic methods (a process which can be automated). Collection can take place daily or weekly and sped up on-demand based on a centralized logistical operations center at a remote location separate from the landing spot. The disassembled gliders can be directly shipped to a lab for refurbishment, shipped to another launch location or stored at their landing location which can also double as a launch location.

Recording of data, and in the exemplary embodiment, by way of digital camera 342, can take place in a subsequent step 560 or for the entire duration that the payload system 310 is in flight, or for any one or more phases of flight. The gimbaled camera 342 or a non-gimbaled camera can collect high-resolution images. When using an imaging device on an automated gimbal, aerial photos can be taken of the ground according to a pre-programmed set of coordinates. A wide-angle lens can be used to collect a large ground coverage area, or a telephoto lens is used to collect high-resolution images. When a telephoto lens is used, a pre-programmed grid pattern 326 is used to collect a large number of photos of the ground so that a known picture overlap is used and that very high-resolution mosaics can be made for mapping or GIS purposes. A telephoto lens can be used for collecting photos of the ground at nadir (down) or at a perspective angle. Perspective photos of the ground can be captured perpendicular to the flight path so that a large ground swath can be covered as the balloon system flies overhead.

The LTA mechanism can be configured to navigate over a desired location on the ground by choosing an appropriate launch location on the ground, and using knowledge of the atmospheric winds as a function of altitude to choose a fixed or variable altitude profile of the LTA vehicle. The float duration of the LTA vehicle may be any time increment from several minutes to several days or weeks.

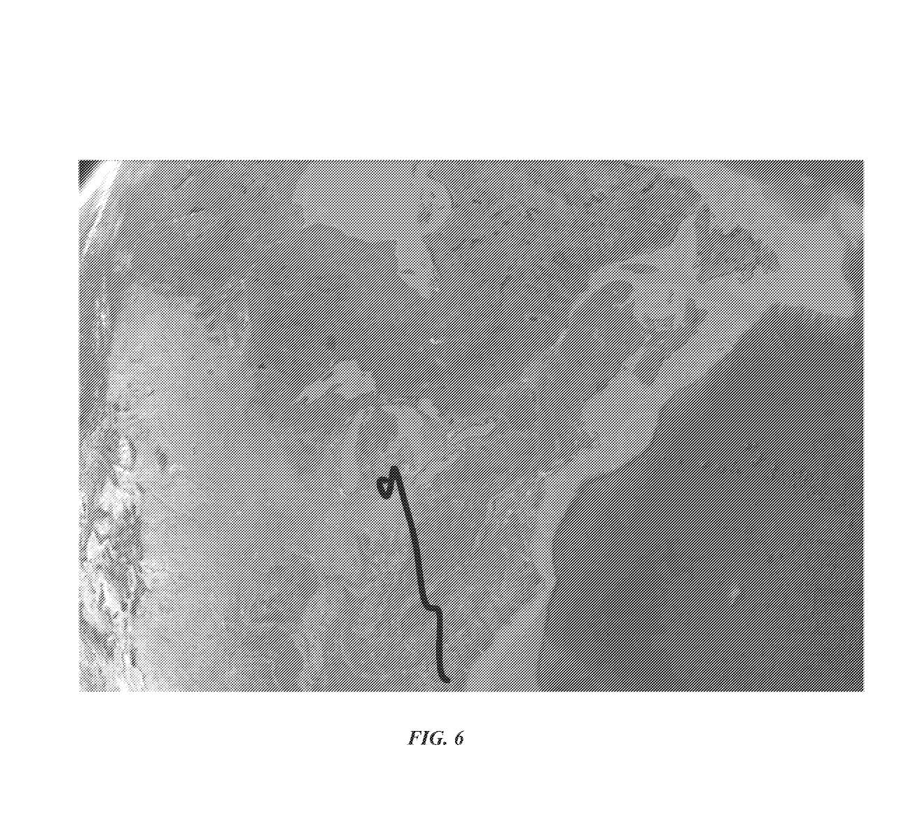

FIG. 6 shows an exemplary flight path of a payload being launched from near Ann Arbor, Mich., travelling through the Earth's atmosphere at a desired altitude taking advantage of atmospheric winds to move the payload in a particular direction and then descent and recovery of the payload around Alexandria, Va.

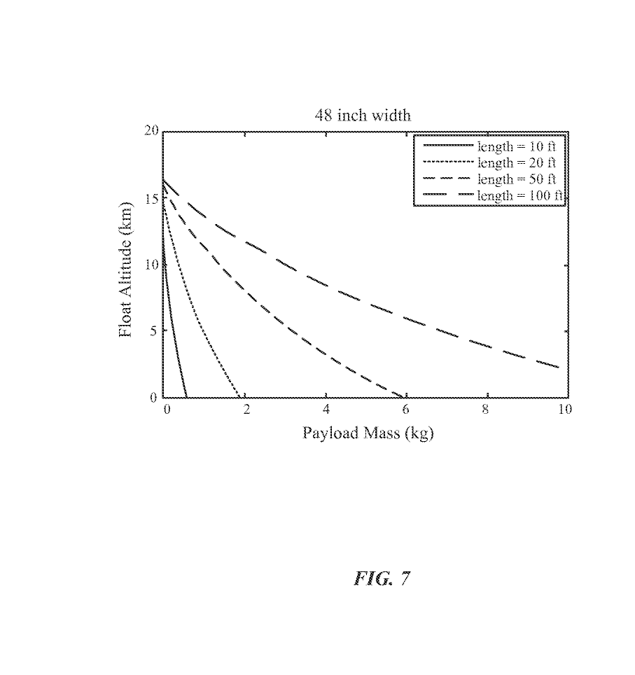

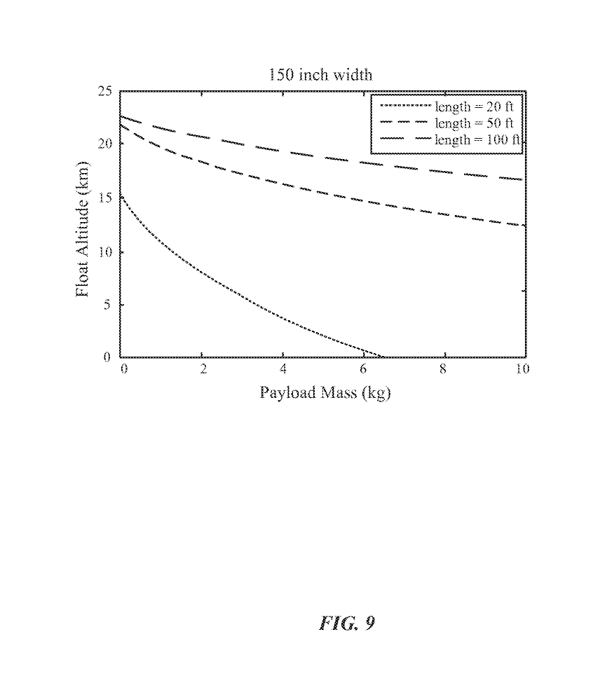

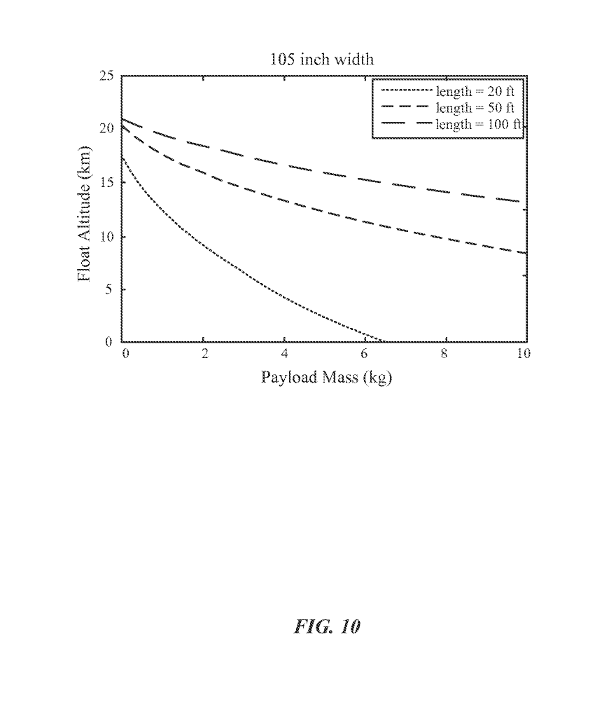

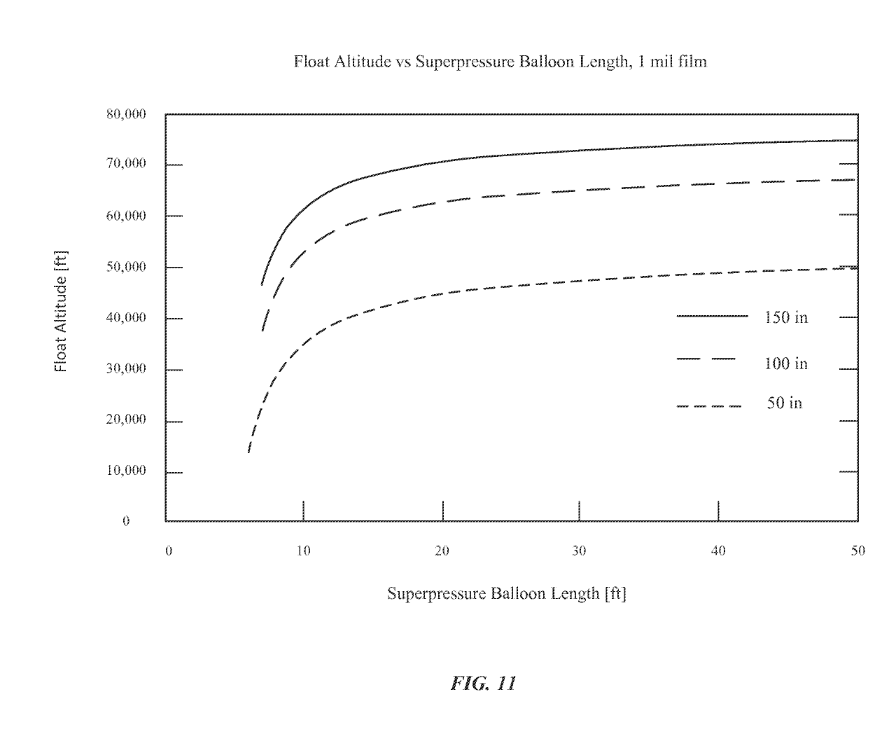

FIGS. 7-11 each show calculated float altitude in accordance with super-pressure balloons having varying widths as a function of payload mass. It should be noted that the length of the tubes could be varied on the ground before launch in order to achieve a specified float altitude.

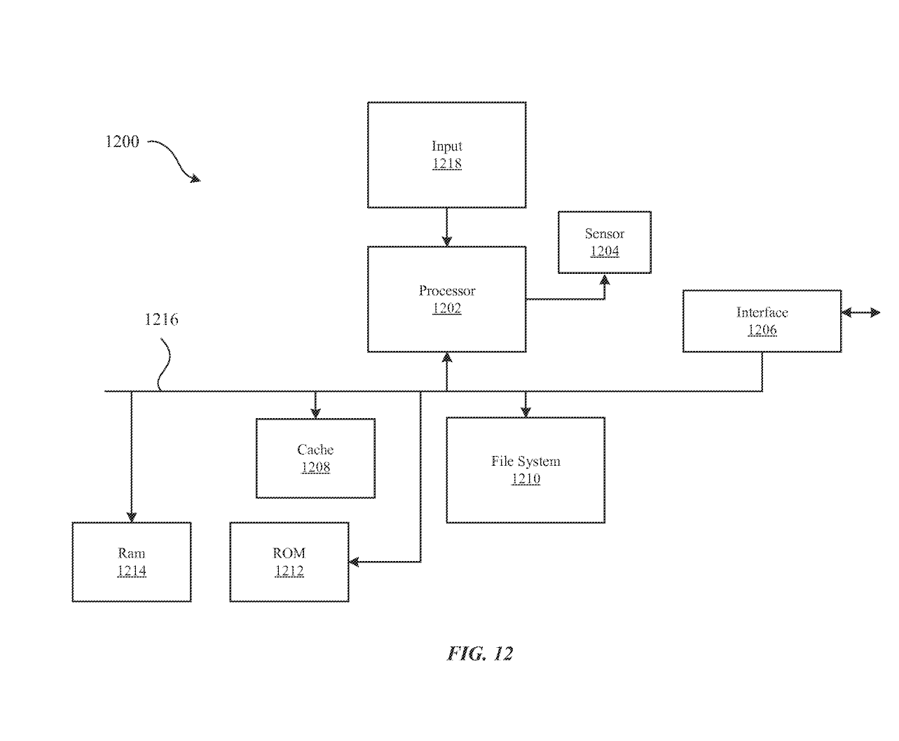

FIG. 12 is a block diagram of an electronic device 1200 suitable for use with the described embodiments. The electronic device 1200 illustrates circuitry of a representative computing device. The electronic device 1200 includes a processor 1202 that pertains to a microprocessor or controller for controlling the overall operation of the electronic device 1200. The electronic device 1200 stores media data pertaining to media items in a file system 1210 and a cache 1208. The file system 1210 is, typically, a storage disk or a plurality of disks. The file system 1210 typically provides high capacity storage capability for the electronic device 1200. However, since the access time to the file system 1210 is relatively slow, the electronic device 1200 can also include a cache 1208. The cache 1208 is, for example, Random-Access Memory (RAM) provided by semiconductor memory. The relative access time to the cache 1208 is substantially shorter than for the file system 1210. However, the cache 1208 does not have the large storage capacity of the file system 1210. Further, the file system 1210, when active, consumes more power than does the cache 1208. The electronic device 1200 can also include a RAM 1214 and a Read-Only Memory (ROM) 1212. The ROM 1212 can store programs, utilities or processes to be executed in a non-volatile manner. The RAM 1214 provides volatile data storage, such as for the cache 1200.

The electronic device 1200 also includes an interface 1206 that couples to a data link 1216. The data link 1216 allows the electronic device 1200 to couple to a host computer for data retrieval. The data link 1216 can be provided over a wired connection or a wireless connection. In the case of a wireless connection, the interface 1206 can include a wireless transceiver useful for real time data transmission.

The various aspects, embodiments, implementations or features of the described embodiments can be used separately or in any combination. Software, hardware or a combination of hardware and software can implement various aspects of the described embodiments. The described embodiments can also be embodied as computer readable code on a non-transitory computer readable medium. The computer readable medium is defined as any data storage device that can store data, which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

The advantages of the embodiments described are numerous. Different aspects, embodiments or implementations can yield one or more of the following advantages. Many features and advantages of the present embodiments are apparent from the written description and, thus, it is intended by the appended claims to cover all such features and advantages of the invention. Further, since numerous modifications and changes will readily occur to those skilled in the art, the embodiments should not be limited to the exact construction and operation as illustrated and described. Hence, all suitable modifications and equivalents can be resorted to as falling within the scope of the invention.

1. A high altitude super-pressure balloon system, comprising:
a plastic film tube having a film tube length, wherein a super-pressure balloon float altitude is selectable in accordance with the film tube length and a given payload mass, wherein the ability to drift at a known and fixed altitude to take advantage of known or unknown wind patterns in order to pass over a desired location or plurality of locations on the ground; and
a payload coupled to the tube of plastic film.

2. The high altitude super-pressure balloon system as recited in claim 1, wherein a fixed altitude is achieved with varying a payload mass by selecting an appropriate film tube length.

3. The high altitude super-pressure balloon system as recited in claim 1, further comprising:
a reinforced banding around a circumference or a longitudinal axis of the plastic film tube.

4. The high altitude super-pressure balloon system as recited in claim 1, wherein the plastic film tube comprises at least two different layers of plastic film, wherein a reinforced banding is sandwiched in between one or more layers of the plastic film.

5. The high altitude super-pressure balloon system as recited in claim 4, wherein the reinforced banding is one of or a combination of the following: a fiberglass tape, a high tensile strength string, a non-reinforced tape, or a plastic tape.

6. The high altitude super-pressure balloon system as recited in claim 1, wherein ends of the plastic film tube are securing using a knot from a gathered material, or sealed with a plastic welder or a sealing device.

7. The high altitude super-pressure balloon system as recited in claim 1, wherein the plastic film tube is storable as a continuous roll of plastic film, wherein a large number of plastic film tubes are separated from the roll of plastic by pre-made perforations, or by cutting the tube at a desired length.

8. The high altitude super-pressure balloon system as recited in claim 1, wherein the plastic film tube has an ability to drift at a known and fixed altitude to pass over a desired location or plurality of locations on the ground.

9. The high altitude super-pressure balloon system as recited in claim 1, comprising: a biodegradable or environmentally friendly material.

10. The high altitude super-pressure balloon system as recited in claim 1, comprising: a reinforcement mechanism around a circumference in order to increase a total burst strength of the balloon, and increase a burst pressure of the balloon.

11. The high altitude super-pressure balloon system as recited in claim 1, comprising separate and exterior to additional balloon envelops or nested balloon envelopes.

12. The high altitude super-pressure balloon system as recited in claim 1, wherein the super-pressure balloon is filled with a known amount of helium, hydrogen, air on the ground in order to select the altitude at which the super-pressure balloon will go super-pressure such that the pressure inside of the balloon exceeds the pressure outside of the balloon and provides negative buoyancy to an overall balloon system.

13. A method of manufacturing a super-pressure balloon, comprising:
acquiring a tubular material capable of being formed in a collapsed and expanded configuration having a length longer than an intended length of the super-pressure balloon;
removing a desired length of tubular material to create the super-pressure balloon; and
sealing the terminal ends of the tubular material to form the super-pressure balloon.

14. The method as recited in claim 13 further comprising pressurizing the tubular material to form a tubular length of super-pressure balloon.

15. The method as recited in claim 13 wherein the tubular material is stored in a flattened configuration.

16. The method as recited in claim 13 wherein the tubular the material is stored on a roll.

17. The method as recited in claim 13 wherein a terminal end is sealed by tying an end of the material.

18. The method as recited in claim 13 wherein the roll of stored tubular material comprises sufficient length of continuous material to create multiple balloons.

19. The method as recited in claim 13 wherein the intended length of the super-pressure balloon is selected based on the selected altitude for flight.

20. The method as recited in claim 13 wherein the sealing of the terminal end is by tying, metal banding, zip tying, or combinations thereof.
